(19) United States
(12) Patent Application Publication
(10) Pub. No.: US 2024/0242223 A1
(43) Pub. Date: Jul. 18, 2024

(54) SYSTEMS AND METHODS FOR DYNAMIC RISK-ASSESSED SERIALIZATION OF USER CHALLENGES

(71) Applicant: JPMORGAN CHASE BANK, N.A., New York, NY (US)

(72) Inventors: Goran LONCARIC, Frisco, TX (US); Gerardo GEAN, Plano, TX (US); Bipin MORE, Edison, NJ (US); Melissa M. DIETZ, Elkton, MD (US); Jayapal KONAGERI, New York, NY (US); Gilda RAZI, New York, NY (US)

(21) Appl. No.: 18/154,636

(22) Filed: Jan. 13, 2023

(51) Int. Cl. G06Q 20/40; G06Q 20/38

(52) U.S. Cl. CPC G06Q 20/4016; G06Q 20/3821

(57) ABSTRACT

A method for dynamic risk-assessed serialization of user challenges may include a computer program: receiving, from a requesting system, a challenge request for a user action; identifying a first challenge type to present based on the user action; presenting a first challenge for the first challenge type to a user electronic device; receiving, from the user electronic device, a response to the first challenge; verifying the response to the first challenge; determining that a second challenge is necessary based on the response to the first challenge; identifying a second challenge type to present based on the response to the first challenge; presenting a second challenge for the second challenge type to the user electronic device; receiving, from the user electronic device, a response to the second challenge; verifying the response to the second challenge; and returning, to the requesting system, a notification that the challenge request was successful.

### BACKGROUND OF THE INVENTION

### 1. Field Of The Invention

Embodiments generally relate to systems and methods for dynamic risk-assessed serialization of user challenges.

### 2. Description of the Related Art

It is common for an institution to issue a challenge to a user for several purposes. For example, a challenge may be issued to confirm the user's identity, for prudence (e.g., scam awareness), for humanity (e.g., to check that the user is a human and not a bot), etc. Identity challenges seek to attain high confidence that the user interacting with the system is a genuine user and not a fraudster who got in by compromising login (e.g., username/password) credentials. An example of an identity challenge is requiring a user to enter a one-time passcode (OTP) that is sent to the user's registered electronic device by, for example, SMS, email, etc.

A prudence challenge may be used to warn the user of a possible scam and obtain acknowledgement from a user requesting a transaction that the requested transaction has a risk of being a scam, and consent to proceed. An example of a prudence challenge is requiring a user about to send money to a third party to acknowledge reading information regarding common scams before continuing with the transaction.

A humanity challenge may be used to confirm that the user interacting with the system is a human, not a bot. An example of a humanity challenge is a CAPTCHA (e.g., a Completely Automated Public Turing test to tell Computers and Humans Apart) or similar challenge.

In order to confirm the identity of the user before allowing the user to take an action, such as changing a password, updating contacting information, making a payment, etc. In a large organization, challenges may not be applied uniformly, thereby giving an opportunity to an attacker to circumvent the system.

### SUMMARY OF THE INVENTION

Systems and methods for dynamic risk-assessed serialization of user challenges are disclosed. In one embodiment, a method for dynamic risk-assessed serialization of user challenges may include: (1) receiving, by a computer program and from a requesting system, a challenge request for a user action for a user; (2) identifying, by the computer program, a first challenge type to present to the user based on the user action; (3) presenting, by the computer program, a first challenge for the first challenge type to a user electronic device; (4) receiving, by the computer program and from the user electronic device, a response to the first challenge; (5) verifying, by the computer program, the response to the first challenge; (6) determining, by the computer program, that a second challenge is necessary based on the response to the first challenge; (7) identifying, by the computer program, a second challenge type to present to the user based on the user action and/or the response to the first challenge; (8) presenting, by the computer program, a second challenge for the second challenge type to the user electronic device; (9) receiving, by the computer program and from the user electronic device, a response to the second challenge; (10) verifying, by the computer program, the response to the second challenge; and (11) returning, by the computer program and to the requesting system, a notification that the challenge request was successful.

In one embodiment, the user action may include changing a password, updating contact information, a transaction, a transfer of money, etc.

In one embodiment, the first challenge type and the second challenge type may include an identity challenge, a prudence challenge, or a humanity challenge. The first challenge type and the second challenge type may be different.

In one embodiment, the first challenge type and the second challenge type may be further identified based on user information that is available.

In one embodiment, the method may also include determining, by the computer program, that the first challenge for the user action is necessary.

In one embodiment, the response to the first challenge may also include metadata, and the computer program determines that the second challenge is necessary based on the metadata. The metadata may identify a number of attempts to correctly respond to the first challenge, a time to respond to the first challenge, and/or device information for the user device.

According to another embodiment, a system may include: a requesting system that is configured to receive a request for a user action for a user from a user electronic device and a backend executing a computer program that receives a challenge request for the user action, identifies a first challenge type to present to the user based on the user action, presents a first challenge for the first challenge type to a user electronic device, receives a response to the first challenge from the user electronic device, verifies the response to the first challenge, determines that a second challenge is necessary based on the response to the first challenge, identifies a second challenge type to present to the user based on the user action and/or the response to the first challenge, presents a second challenge for the second challenge type to the user electronic device; receives a response to the second challenge from the user electronic device, verifies the response to the second challenge, and returns a notification that the challenge request was successful.

In one embodiment, the user action may include changing a password, updating contact information, a transaction, a transfer of money, etc.

In one embodiment, the first challenge type and the second challenge type may include an identity challenge, a prudence challenge, or a humanity challenge. The first challenge type and the second challenge type may be different.

In one embodiment, the first challenge type and the second challenge type may be further identified based on user information that is available.

In one embodiment, the backend computer program may determine that the first challenge for the user action is necessary.

In one embodiment, the response to the first challenge may also include metadata, and the computer program determines that the second challenge is necessary based on the metadata. The metadata may identify a number of attempts to correctly respond to the first challenge, a time to respond to the first challenge, and/or device information for the user device.

According to another embodiment, a non-transitory computer readable storage medium may include instructions stored thereon, which when read and executed by one or more computer processors, cause the one or more computer processors to perform steps comprising: receiving, from a requesting system, a challenge request for a user action for a user; identifying, a first challenge type to present to the user based on the user action; presenting, a first challenge for the first challenge type to a user electronic device; receiving, from the user electronic device, a response to the first challenge; verifying the response to the first challenge; determining that a second challenge is necessary based on the response to the first challenge; identifying a second challenge type to present to the user based on the user action and/or the response to the first challenge; presenting a second challenge for the second challenge type to the user electronic device; receiving, from the user electronic device, a response to the second challenge; verifying the response to the second challenge; and returning, to the requesting system, a notification that the challenge request was successful.

In one embodiment, the first challenge type and the second challenge type may include an identity challenge, a prudence challenge, or a humanity challenge, and the first challenge type and the second challenge type may be different.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for dynamic risk-assessed serialization of user challenges according to an embodiment;

FIGS. 2A and 2B illustrate a method for dynamic risk-assessed serialization of user challenges according to an embodiment; and

FIG. 3 depicts an exemplary computing system for implementing aspects of the present disclosure.

### DETAILED DESCRIPTION OF PREFERRED EMBODIMENTS

Embodiments generally relate to systems and methods for dynamic risk-assessed serialization of user challenges.

Embodiments may provide uniform application of rules in order to identify when a challenge should be presented, to identify type(s) of challenges to present, to accept a challenge response, to request a re-challenge, etc.

As used herein, a re-challenge refers to a challenge issued after a first challenge is issued. The contents and types of challenges and re-challenges may be the same.

Embodiments may dynamically re-challenge a user in the same session for the same, for the same transaction, etc., depending on how the challenge response. For example, if the first challenge is for the user to enter a OTP that was sent by SMS, although the user may enter the correct OTP, the system may give the phone number to which the SMS message is sent may receive a low ownership score because, for example, it was recently added to the user's profile, is paid for by a third party, was involved in a recent SIM swap attack, etc. In that case, a re-challenge may be identified and issued. The re-challenge may be, for example, a OTP sent to another phone number on file with higher confidence, a OTP sent to an email on file, a request for a scan of a driver's license or passport, entry of a debit or credit card PIN, a request for the user to tap a debit or credit card to a smartphone, asking the user to scan a QR code with a registered application, etc.

After passing the second challenge the confidence is higher, but may still not be high enough for high risk/high value transactions. Thus, a second re-challenge may be presented using any suitable method.

In embodiment, with the aim to reach a desired confidence score, the challenge process may be repeated any suitable number of times. The number of times may be limited by, for example, the choice of methods the system has implemented, and attributes present on file for the user.

Challenges and re-challenges may be serialized in any fashion to achieve confidence in some or all three dimensions, such as identity, prudence, and humanity. For example, embodiments may first challenge entity by asking the user to enter the OTP sent via SMS to a registered phone and then enter a debit card PIN. A humanity challenge may then be presented to ask the user to solve a CAPTCHA. A prudence challenge asking the user to attest that a given transaction is not a scam and to confirm that the user wants to proceed may then be presented. This example illustrates the flexibility in which challenges may be ordered in any sequence, including a sequence that may be determined to minimize risks or achieve high confidence in identity, prudence, and/or humanity aspects of the user interacting with the system.

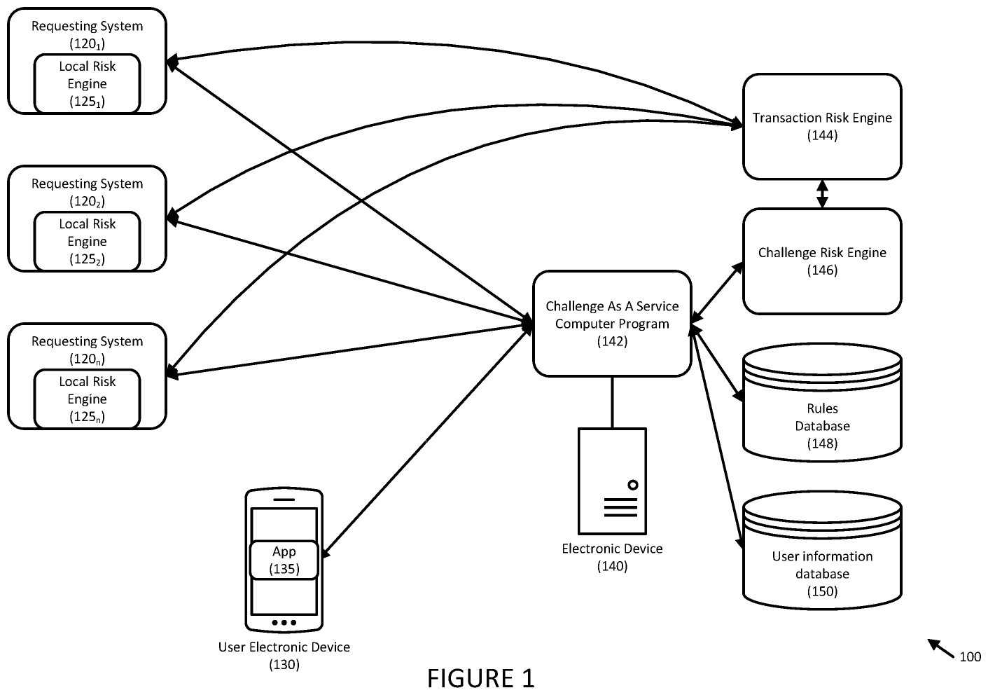

Referring to FIG. 1, a system for dynamic risk-assessed serialization of user challenges is disclosed according to an embodiment. System 100 may include a plurality of requesting systems 120 (e.g., 120₁, 120₂, . . . 120ₙ), which may be any system or service that may request step-up authentication in response to a user request. Requesting systems 120 may include any system that may need to authenticate the user before allowing an action, including payment systems, call centers, banking systems, credit systems, merchants, password systems, etc.

In one embodiment, requesting systems 120 may be within the same organization, may be third party systems, etc.

In one embodiment, each requesting system 120 may include local risk engine 125 (e.g., 125₁, 125₂, . . . 125ₙ), which may determine whether or not step-up authentication is necessary.

In another embodiment, local risk engine 125 may be optional and all decisions on step-up authentication may be outsourced to challenge as a service computer program 142 and/or transaction risk engine 144.

System 100 may further include electronic device 140, which may include servers (e.g., physical and/or cloud-based), computers (e.g., workstations, desktops, laptops, notebooks, tablets, etc.), Internet of Things (IoT) appliances, etc. Electronic device 140 may execute challenge as a service computer program 142, which may manage the determination of a type of challenge to issue the user, the communication channel over which the challenge will be issued, the verification of the correctness of the response to the challenge, and the determination as to whether re-challenge(s) are necessary.

Examples of challenges and re-challenges include short messaging service (SMS)-delivered one-time passcodes, notices pushed to mobile applications, debit/ATM card Personal Identification Number (PIN) or Card Verification Value (CVV) entry, document scan (e.g., driver's license, passport, etc.), entry of biometrics (e.g., face, fingerprint, voiceprint, etc.), entry of wireless card data via tap, hard token data entry, reasonableness challenges (e.g., present a question to the user that requires entry of a well-known response), a bot challenge (e.g., a Completely Automated Public Turing test to tell Computers and Humans Apart (CAPTCHA) or similar challenge), etc.

Challenge as a service computer program 142 may interface with challenge risk engine 146, rules database 148, and user information database 150. Together, these elements may provide a centralized mechanism that applies the same standards for risk and the same rules to all systems. Challenge risk engine 146 and requesting system(s) 120 may interface with transaction risk engine 144.

In one embodiment, the rules applied by transaction risk engine 144 and/or challenge risk engine 146 may be manually entered in rules database 148; in another embodiment, the rules may be learned using machine learning.

Transaction risk engine 144 may apply rules, such as when a challenge or re-challenge is necessary, etc. to a transaction. For example, transaction risk engine 144 may receive transaction details, such as a transaction amount, a merchant, a date/time, in-person or remote, transaction location, etc. and may determine whether a challenge is necessary.

In one embodiment, transaction risk engine may also determine a required confidence score in the challenge/re-challenge response in order to return a pass notification to requesting system 120. The required confidence score may be provided by requesting system 120.

Challenge risk engine 146 may identify a challenge or re-challenge to present to the user. For example, challenge risk engine 146 may identity an identity challenge, a prudence challenge, and/or a humanity challenge to present to the user. The challenge or re-challenge may be selected based on the confidence score, the contact information for the user in user information database 150, the type of user electronic device 130 (e.g., NFC-enabled or not), etc.

Challenge risk engine 146 may receive metadata for the challenge or re-challenge response, such as number of attempts to respond correctly, the amount of time to respond to challenge, device information for device on which response was entered, etc., to determine a confidence level in the challenge response. Challenge risk engine 146 may also account for the impact of the requested response (e.g., a change in a transaction account password versus a one-time low dollar payment) to determine whether a re-challenge is necessary.

Challenge risk engine 146 may identify acceptable challenges for a risk level. For example, based on the impact of the requested change, challenge risk engine 146 may require that the challenge response be received from user electronic device 130 that is registered to the user.

Challenge as a service computer program 142 may also interface with user information database 150 that may store user information that may be used to verify challenge responses. User information database 150 may also store certain metrics and data, such as how long ago a PIN was changed, when a biometric was uploaded, registered user device information, etc. Challenge risk engine 146 may apply the data and metrics in order to determine the type of challenge to issue, and the types of challenges that are less reliable (e.g., accepting a PIN that has been changed within 24 hours, accepting a biometric that has been recently added, etc.).

Challenges may be issued to user electronic device 130, which may be a computer (e.g., workstation, desktop, laptop, notebook, tablet, etc.), smart devices (e.g., smart phones, smart watches, etc.), IoT devices, etc. User electronic device 130 may execute one or more computer applications 135, such as a phone application, a messaging (e.g., SMS) application, an institution-issued application that may receive in-app messages from challenge as a service computer program 142, etc.

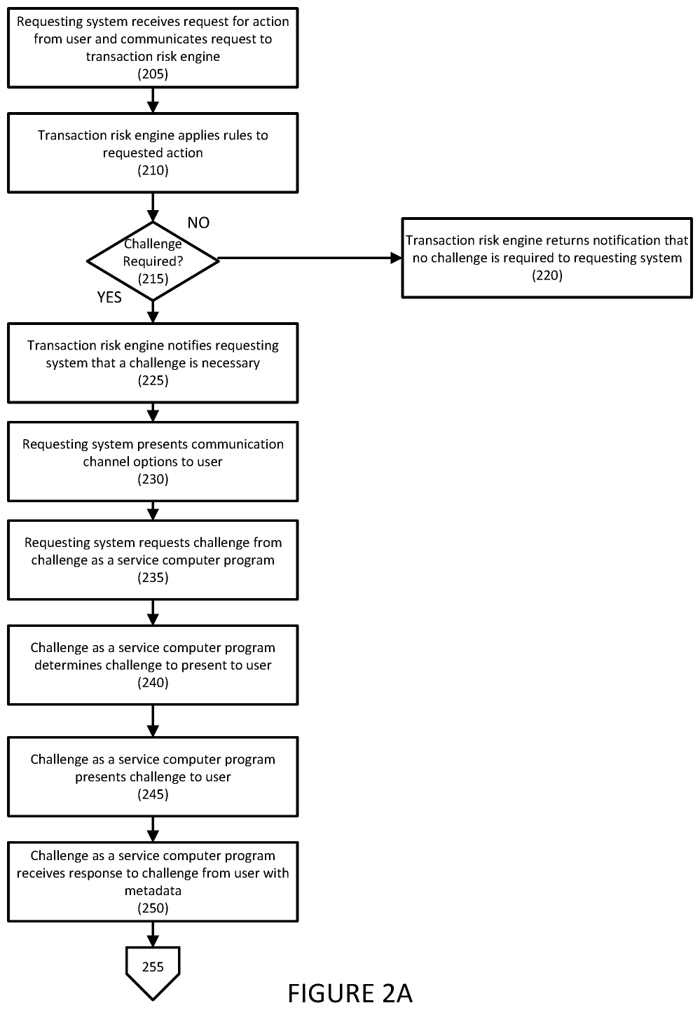

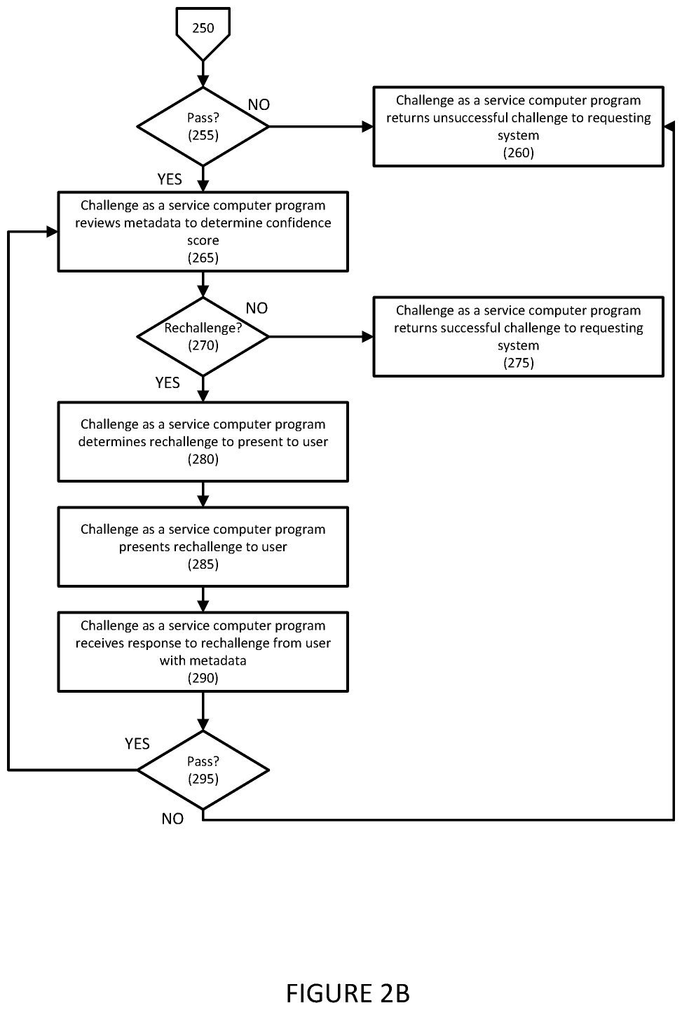

Referring to FIGS. 2A and 2B, a method for dynamic risk-assessed serialization of user challenges is provided according to an embodiment.

In step 205, a computer program at a requesting system may receive a request for action from a user, a third party acting as a proxy for the user (e.g., third party wallets, merchants, etc.). Examples of actions that may be requested include changing a password, updating contact information for an account, making a purchase, transferring money, opening an account, redeeming rewards, receiving travel notifications, registering a new device, signing into a device, etc. The action may be any action for which user identity confirmation (e.g., authentication), user prudence confirmation, a humanity check, etc. may be desired or required.

The computer program at the requesting system may communicate the requested action to a transaction risk engine to determine if a challenge is necessary. The computer program at the requesting system may provide information on the requested action (e.g., type of action, accounts, amounts, etc.), a user identifier, etc. to the challenge as a service computer program.

Alternatively, the requesting system may determine if a challenge is necessary without involving the transaction risk engine.

In step 210, the transaction risk engine may determine if a challenge for the requested action is necessary. In one embodiment, the transaction risk engine may apply one or more rules from a rules database to determine if the action requires a challenge. If a challenge is necessary, the transaction risk engine may determine a required confidence level in the challenge response for the challenge response to be successful.

In one embodiment, the transaction risk engine may also identify one or more types of challenges to issue (e.g., identity, prudence, humanity) to issue.

If, in step 215, a challenge is not necessary, in step 220, the transaction risk engine or the challenge as a service computer program may notify the requesting system that a challenge is not necessary. The requesting system may then execute the requested action.

If a challenge is necessary, in step 225, the transaction risk engine or the challenge as a service computer program may optionally notify the requesting system that a challenge is necessary.

In step 230, the computer program at the requesting system may present communication channel selection options to the user. For example, the computer program may identify registered communication channels, such as SMS numbers, email, in-app, etc. and the user may select a preferred communication channel for receiving the challenge.

In step 235, the computer program at the requesting system may communicate a request the issuance of a challenge from the challenge as a service computer program with user identifier. It may also provide the communication channel selection.

In step 240, the challenge as a service computer program may determine a challenge to present to the user using, for example, a challenge risk engine. In one embodiment, the challenge risk engine may identify the challenge type (e.g., identity, prudence, humanity, etc.) based on the type of action, the level of risk associated with allowing the action, a required confidence score, information from the transaction risk engine, the user information available, the type of user electronic device, the communication channels available, etc.

In one embodiment, rules may specify the type of challenge to present. The rules may be developed and deployed iteratively, and may be continually refined based on production performance of these rules. For example, an identity challenge trigger rule may trigger a challenge (e.g., an identity challenge if the user is logging into a new device, an unrecognized device, etc. As another example, a tenure rule may trigger an identity challenge if a money movement transaction is going to a recipient recently added (e.g., within 14 days). Rules to trigger identity challenges may also be based on the amount of the transaction, the type (e.g., wire transfer), recoverability, etc.

The type of identity challenge may also depend on the above-mentioned transaction attributes as well as available and eligible credentials. For example, a user may have a one primary phone number on file that was changed within a certain period of time (e.g., two weeks). Based on this information, the challenge risk engine may disallow an OTP being sent to that phone number, and may instead return SMS to that phone and return a Debit PIN or drivers license scan as eligible challenge methods. The rules may filter the challenge options based on availability (e.g., the credentials that are available) and eligibility (e.g., what credentials are deemed “safe”). Rules for availability may be applied by the challenge risk engine, and the rules for eligibility may be applied by the transaction risk engine.

Prudence and humanity challenges may be identified and selected in a similar manner. For example, a transaction may be suspected to be a romance scam (this is based on rules looking at recipient data, amounts, etc.). Thus, the challenge risk engine may present a challenge describing how romance scams work and what the user should look out for to recognize them and then ask the user to attest that this is not a romance scam.

As another example, an unusually fast transition from page to page or http requests may have the markings of a bot request as identified by bot recognition software. This may trigger a humanity challenge which may require the user to solve a CAPTCHA puzzle.

In one embodiment, a confidence score may be used to identify the challenge to present. For example, there may be a confidence score for whether the challenge to present has been identified properly (e.g., has the issue and the need for a challenge to mitigate risk been properly identified) and a confidence score that the risk has been reduced enough to let the transaction through. The second confidence score may increase as the successfully responds to challenges.

In one embodiment, the transaction risk engine and the challenge risk engine may train machine learning algorithms that may be used instead of, or to supplement, the rules.

In step 245, the challenge as a service computer program may present the challenge to the user. In one embodiment, the challenge as a service computer program may retrieve user contact information and may communicate the challenge to the user using a user SMS address, a user email address, a user registered computer application, a user phone number, etc.

In one embodiment, the challenge may be presented over the communication channel selected by the user.

Examples of challenges may include the entry of a one-time passcode, the entry of account information (e.g., PIN, CVV, etc.), debit/credit card reading by tap, document scanning, entry of biometrics, in-application verification, etc.

In step 250, the challenge as a service computer program may receive a challenge response to the challenge from user. The challenge response may be received by SMS, email, from an application on the user electronic device, etc.

In one embodiment, the challenge response may include metadata, such as the amount of time to enter a correct challenge response, the number of attempts to enter the correct challenge response, device information for the device that the challenge response was entered into, etc.

In step 255, the challenge as a service computer program may determine whether the challenge response is correct. If it is not, in step 260, the challenge as a service computer program may return an indication or notification to the computer program at the reporting system that the challenge was unsuccessful.

If the challenge response was successful, in step 265, the challenge as a service computer program may review the metadata to and may determine a confidence score in the challenge response. In one embodiment, one or more confidence scores may be calculated by the challenge risk engine based on if and how the user passes individual challenges, a series of challenges, etc. The confidence score may be used to determine if a re-challenge is necessary.

For example, if the challenge response took too long, took a number of retries, was from an electronic device that was only recently registered to the user (e.g., has a low confidence in ownership), involved a PIN that was recently changed, involves less than a 100% match between a document and stored information, etc. the challenge as a service computer program may determine that a re-challenge is necessary.

High value transfers may require higher confidence score thresholds than low value monetary transactions. Such high value transactions may require multiple serialized challenges (e.g., OTP on primary phone, drivers license scan, and debit PIN entry).

Other reasons for a re-challenge may include an amount associated with the action, a reversibility of the action, etc.

In another embodiment, a re-challenge may be necessary to provide a different challenge type. This may be based on the type of action requested. For example, for a money transfer challenge, even if an identity challenge was successful, a prudence challenge may still be presented for the user.

If, in step 270, a re-challenge is not necessary, in step 275, the challenge as a service computer program may return a notification that the challenge was successful to the computer program at the requesting system.

If, in step 270, a re-challenge is not necessary, in step 280, the challenge as a service computer program may determine a re-challenge to present to the user. The re-challenge may be a similar type of challenge as the challenge but to a different communication channel (e.g., the challenge may be an OTP to a SMS address, and the re-challenge may be an OTP to an email address), or it may be different challenge type.

In step 285, the challenge as a service computer program may present the re-challenge to the user. This may be similar to step 245, above.

In step 290, the challenge as a service computer program may receive a re-challenge response from the user. This may be similar to step 250, above.

In step 295, the challenge as a service computer program may determine whether the re-challenge response is correct. If it is not, in step 260, the challenge as a service computer program may return an indication or notification to the computer program at the reporting system that the challenge was unsuccessful. In one embodiment, the notification may be binary, such as a successful challenge or an unsuccessful challenge, regardless of how many challenges/re-challenges are presented.

If the re-challenge response was successful, the process may return to step 265.

As described above, re-challenges may be presented until a certain confidence level is achieved or all combinations of challenges and communication channels have been exhausted.

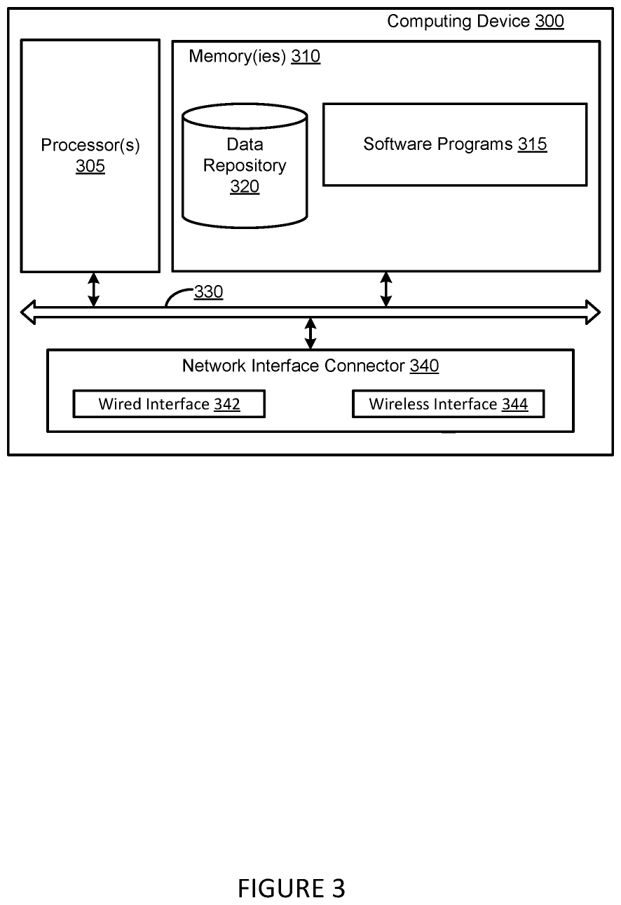

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” maybe utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for dynamic risk-assessed serialization of user challenges, comprising:
receiving, by a computer program and from a requesting system, a challenge request for a user action for a user;
identifying, by the computer program, a first challenge type to present to the user based on the user action;
presenting, by the computer program, a first challenge for the first challenge type to a user electronic device;
receiving, by the computer program and from the user electronic device, a response to the first challenge;
verifying, by the computer program, the response to the first challenge;
determining, by the computer program, that a second challenge is necessary based on the response to the first challenge;
identifying, by the computer program, a second challenge type to present to the user based on the user action and/or the response to the first challenge;
presenting, by the computer program, a second challenge for the second challenge type to the user electronic device;
receiving, by the computer program and from the user electronic device, a response to the second challenge;
verifying, by the computer program, the response to the second challenge; and
returning, by the computer program and to the requesting system, a notification that the challenge request was successful.

2. The method of claim 1, wherein the user action comprises changing a password or updating contact information.

3. The method of claim 1, wherein the user action comprises a transaction or a transfer of money.

4. The method of claim 1, wherein the first challenge type and the second challenge type comprise one of an identity challenge, a prudence challenge, and a humanity challenge.

5. The method of claim 4, wherein the first challenge type and the second challenge type are different.

6. The method of claim 1, wherein the first challenge type and the second challenge type are further identified based on user information that is available.

7. The method of claim 1, further comprising:
determining, by the computer program, that the first challenge for the user action is necessary.

8. The method of claim 1, wherein the response to the first challenge further comprises metadata, and the computer program determines that the second challenge is necessary based on the metadata.

9. The method of claim 8, wherein the metadata comprises a number of attempts to correctly respond to the first challenge, a time to respond to the first challenge, and/or device information for the user device.

10. A system, comprising:
a requesting system that is configured to receive a request for a user action for a user from a user electronic device; and
a backend executing a computer program that receives a challenge request for the user action, identifies a first challenge type to present to the user based on the user action, presents a first challenge for the first challenge type to a user electronic device, receives a response to the first challenge from the user electronic device, verifies the response to the first challenge, determines that a second challenge is necessary based on the response to the first challenge, identifies a second challenge type to present to the user based on the user action and/or the response to the first challenge, presents a second challenge for the second challenge type to the user electronic device; receives a response to the second challenge from the user electronic device, verifies the response to the second challenge, and returns a notification that the challenge request was successful.

11. The system of claim 10, wherein the user action comprises changing a password or updating contact information.

12. The system of claim 10, wherein the user action comprises a transaction or a transfer of money.

13. The system of claim 10, wherein the first challenge type and the second challenge type comprise one of an identity challenge, a prudence challenge, and a humanity challenge.

14. The system of claim 13, wherein the first challenge type and the second challenge type are different.

15. The system of claim 10, wherein the first challenge type and the second challenge type are further identified based on user information that is available.

16. The system of claim 10, wherein the backend computer program determines that the first challenge for the user action is necessary.

17. The system of claim 10, wherein the response to the first challenge further comprises metadata, and the computer program determines that the second challenge is necessary based on the metadata.

18. The system of claim 17, wherein the metadata comprises a number of attempts to correctly respond to the first challenge, a time to respond to the first challenge, and/or device information for the user device.

19. A non-transitory computer readable storage medium, including instructions stored thereon, which when read and executed by one or more computer processors, cause the one or more computer processors to perform steps comprising:
receiving, from a requesting system, a challenge request for a user action for a user;
identifying, a first challenge type to present to the user based on the user action;
presenting, a first challenge for the first challenge type to a user electronic device;
receiving, from the user electronic device, a response to the first challenge;
verifying the response to the first challenge;
determining that a second challenge is necessary based on the response to the first challenge;
identifying a second challenge type to present to the user based on the user action and/or the response to the first challenge;
presenting a second challenge for the second challenge type to the user electronic device;
receiving, from the user electronic device, a response to the second challenge;
verifying the response to the second challenge; and
returning, to the requesting system, a notification that the challenge request was successful.

20. The non-transitory computer readable storage medium of claim 19, wherein the first challenge type and the second challenge type comprise one of an identity challenge, a prudence challenge, and a humanity challenge, and the first challenge type and the second challenge type are different.
